(19) United States
(12) Patent Application Publication
(10) Pub. No.: US 2009/0250364 A1
(43) Pub. Date: Oct. 8, 2009

(54) Portable container for a hand-held power tool

(75) Inventors: Uwe Gerold, Lindau (DE); Joachim Keck, Eschen (DE); Norbert Welte, Klaus (AT)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/384,273

(22) Filed: Apr. 1, 2009

(30) Foreign Application Priority Data
Apr. 3, 2008 (DE) 10 2008 000 974.1

(51) Int. Cl. A45C 11/00; G01S 1/00; H04W 4/00

(52) U.S. Cl. 206/349; 342/357.06; 455/466

(57) ABSTRACT

A portable container (70) for a hand-held power tool (10) has electronics and electronics interface (155) between the hand-held power tool (10) and the container electronics that contain a remote data transmission device (30) for wireless, network-supported digital remote data transmission with a data processing and control unit (150), a wireless transmitting and receiving unit communicating a processing and control unit (150), and a radio antenna (32), with the electronics interface (155) being designed for local data transmission between the remote data transmission device (30) and a hand-held power tool (10).

### BACKGROUND OF THE INVENTION

1. Field of the Invention

The present invention is directed to a portable container for a hand-held power tool including electronics and an electronic interface provided between the container electronics and the power tool.

2. Description of the Prior Art

Containers of the type mentioned above are formed, e.g., as cases for hand-held power tools in the form of fastener driving tools (which are operated electrically or with solid, gaseous, or liquid fuels or also with compressed air), such as hammer drills, chisel devices, drilling machines, combination hammers, demolition hammers, screw driving tools, grinding tools, circular saws, chain saws, and saber saws.

DE 94 16 057 U1 discloses a portable container of the generic type which is formed as a case for a hand-held power tool and which has a housing with a cover which is pivotally arranged. The housing forms a container space for receiving the hand-held power tool. An electronics interface in the form of a connector for electrically contacting a terminal at the power tool is arranged in the receiving space of the container and is connected by a cable to an electronics component which is formed as an adapter and can be removed from the container. After connecting the adapter to an external power source, the power tool is supplied with electrical energy, e.g., to charge a battery located in the power tool.

It is disadvantageous that the electronics component functions only as a line-voltage adapter and can only feed a charging current to the power tool located in the container through the interface connected to the electronics component.

In modern hand-held power tools, however, it is desirable to monitor and track power tool functions and operating states so that, for example, any malfunctions or operating errors which may occur are detected as early as possible—ideally before they happen—and countermeasures can be taken.

U.S. Pat. No. 6,123,241 discloses a hand-held power tool which is formed as a fastener setting power tool and which has a monitoring system which lets the user know when upkeep or repairs must be carried out on the fastener driving tool. To this end, the monitoring system has a microprocessor that receives input data from different sensors. For example, the fuel pressure is monitored by a pressure sensor. Data can be downloaded from the monitoring system to an external personal computer via a corresponding interface. For this purpose, the power tool must be connected to the personal computer.

It is disadvantageous that the power tool must be located in the immediate vicinity of a personal computer in order to transfer data from the power tool to the personal computer.

### SUMMARY OF THE INVENTION

It is the object of the present invention to provide a portable container for a hand-held power tool of the kind mentioned above which makes it possible to send power tool data (information about the power tool functions and operating states) and measurement data of the hand-held power tool to an evaluation location in a simple manner.

This and other objects of the present invention, which will become apparent hereinafter, are achieved by providing a portable container for a hand-held power tool according to claim 1. Accordingly, the electronics of the container contain a remote data transmission device for wireless, network-supported digital remote data transmission, a data processing and control unit, a wireless transmitting and receiving unit that communicates with the data processing and control unit, and with a radio antenna. The electronics interface is designed for local data transmission between the remote data transmission device and the hand-held power tool.

As a result of the use of a remote data transmission device, data can be sent from the power tool to an evaluation location virtually from any point on earth independent from the location, without the need for the power tool to be located in the vicinity of an evaluation location of this kind, e.g., a personal computer or the like. Communication can be bidirectional so that data can also be sent to the power tool through the container.

A manually actuated switching device is advantageously provided for activating the remote data transmission device so that a data transmission between the power tool and the container and between the container and the evaluation location can be activated so as to be controlled by the user. This has the additional advantage that data interrogation and data transmission can be carried out through the container also with a plurality of power tools in succession, and the user manually initiates every data interrogation and data transmission with the switching device. The switching device can be formed, e.g., as a pushbutton switch.

In a user-friendly embodiment of the invention, the manually actuated switching device is accessibly arranged at an outer side of a container wall.

In an advantageous manner, the wireless transmitting and receiving unit is formed as a GSM module. GSM modules of this kind are available as standardized components so that a remote data transmission device can be applied inexpensively in a power tool. GSM stands for Global System for Mobile communications and is used, for example, in commercially available mobile telephones. By Global System for Mobile communications is also meant, according to the invention, systems using the EDGE, HSCSD or UMTS standards.

Further, it is advantageous when a position determining device for global positioning is provided in addition to the remote data transmission device and communicates with the data processing and control unit. As a result of this step, the data to be sent by the remote data transmission device is supplemented by a position indicator for the current location of the container (and therefore also the current position of the power tool), which is particularly advantageous for preventing theft. Further, certain data such as, e.g., ambient temperature data, can be related to the position and geography of the area in which the power tool is used.

It is advantageous when the position determining device has a separate antenna. The separate antenna can ensure optimal reception characteristics for the reception of satellite-generated position data.

The position determining device advantageously has a GPS module which can be obtained inexpensively as a standardized component. GPS is an acronym for “Global Positioning System” as used, e.g., in commercial navigation equipment.

It can be ensured that reception will not be affected by the power tool in the container when the radio antenna and the antenna are arranged next to an outer wall of the container.

It is advantageous in technical respects when the GSM module and the GPS module are combined to form one constructional unit so that existing power tools need only be adapted slightly for outfitting with a remote data transmission device and position determining device. Constructional dimensions, power consumption and complexity can be reduced in this way.

It is further advantageous when power tool data and measurement data of the hand-held power tool which is provided with a control unit for processing measurement data and for controlling device functions can be sent from the data processing and control unit of the electronics component in the container to an evaluation location by the remote data transmission device through SMS (Short Message Service) so that a simple and reliable data transmission is ensured.

Further, it is advantageous when power tool control parameters, control programs and control program parts can be sent to the data processing and control unit by the remote data transmission device through SMS so that the control unit of the power tool can be re-programmed remotely in a simple manner, since the data need only be sent via the electronics component interface to the control unit of the power tool. The remote data transmission device retrieves an SMS message in the wireless network after being awakened from a sleep mode.

The novel features of the present invention which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a partially cross-sectional, side view of a portable container according to the invention, with a hand-held power tool formed as a fastener driving power tool, in partial longitudinal section;

FIG. 2 a schematic view of the control unit of the hand-held power tool shown in FIG. 1; and

FIG. 3 an operational diagram.

### DETAILED DESCRIPTION OF THE PREFERRED EMBODIMENT

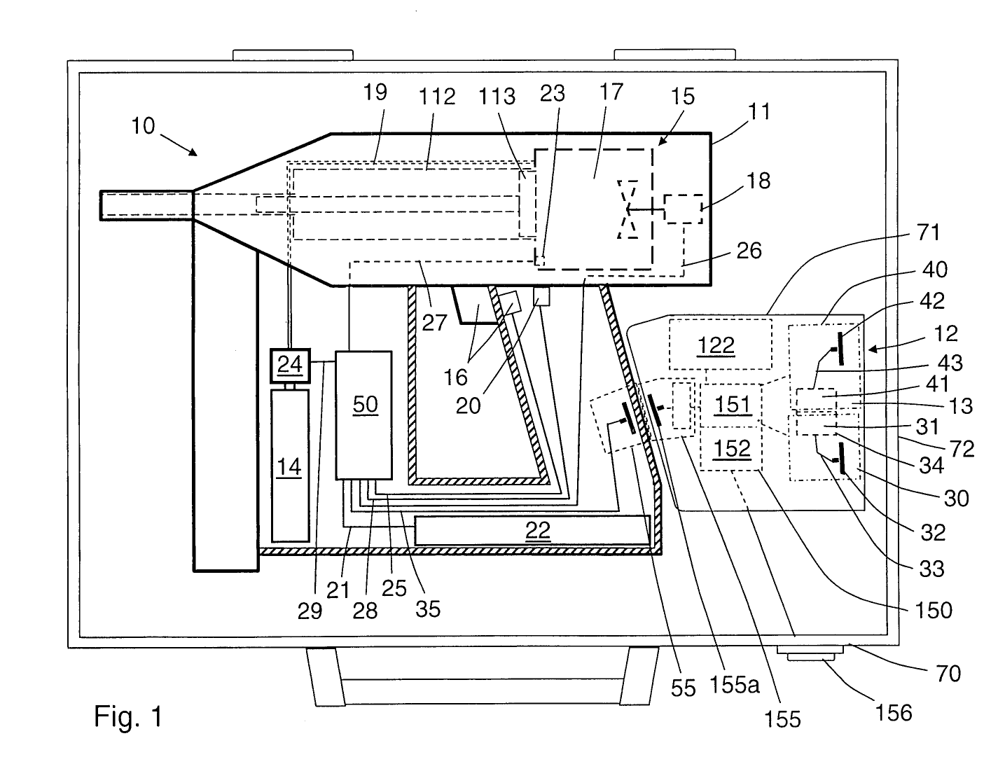

FIG. 1 shows a portable container 70 according to the invention which is formed as a case with a hand-held power tool 10 located therein and which is formed as a combustion-powered fastener setting power tool.

The power tool 10 has a housing, designated generally by 11, which is formed of one or more parts and in which a drive 15 is arranged. A fastening element such as a nail, bolt, etc. can be driven into a workpiece through the drive 15. The fastening elements can be stored, for example, in a magazine at the power tool 10.

The drive 15 includes a combustion chamber 17 and a guide cylinder 112 in which a setting piston 113 is arranged so as to be axially displaceable. As can further be seen from FIG. 1, a trigger switch 16 is arranged at a handle area 12 of the power tool 10, with an ignition device 23, e.g., a spark plug, in the combustion chamber 17 can be actuated when the power tool 10 has been pressed against a workpiece. In addition to the trigger switch 16 mentioned above, additional switches such as, e.g., contact pressure switches, combustion chamber switches or magazine switches can also be provided.

The power tool 10 which is formed in the present embodiment as a fastener power tool, can be operated with a combustion gas or with a vaporizable liquid fuel which is provided in a fuel reservoir 14, e.g., a fuel canister, shown in FIG. 1. A fuel line 19 leads from the fuel reservoir 14 to the combustion chamber 17. A metering device 24 with which the amount of fuel needed for a respective setting process can be metered is interposed in the fuel line 19.

A ventilator which is arranged in the combustion chamber 17 and can be driven by a ventilator motor 18 serves to generate a turbulent flow regime of an oxidant/fuel mixture located in the closed combustion chamber 17 and to flush out the open combustion chamber 17 with fresh air after a completed setting process.

An electrical energy source 22 in the form of at least one battery supplies the electrical consumers of the power tool 10, e.g., the ignition device 23 and the ventilator motor 18, with electrical energy. The battery or batteries can be arranged exchangeably at the tool 10.

Further, at least one other sensor 20, e.g., a temperature sensor for monitoring the power tool temperature or ambient temperature, a pressure sensor for the fuel pressure, a pressure sensor for the atmospheric pressure, an acceleration sensor, a position sensor, a proximity sensor (e.g., for detecting the position of a fastener or tool), a Hall sensor (e.g., for measuring the speed of the setting piston), a humidity sensor, a vibration detector, a CCD receiver, or a microphone, is provided at the power tool 10. Rotation meters or torque meters, for example, could also be provided as a sensor 20, particularly in a rotary power tool.

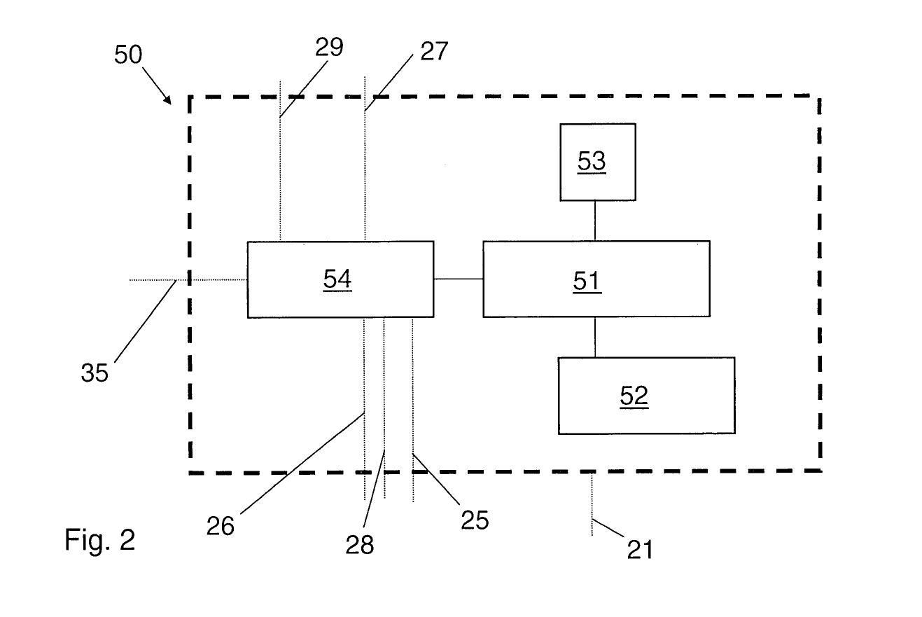

A control unit which is designated in its entirety by 50 and is shown in FIGS. 1 and 2 is provided for controlling and monitoring the power tool functions of the power tool 10. The control unit 50 is connected to the electrical power source 22 by a first electrical line 21. Further, for the purpose of controlling and monitoring device functions, the control unit 50 is connected to the trigger switch 16 by a second electrical line 25, to the ventilator motor 18 by a third electrical line 26, to the ignition device 23 by a fourth electrical line 27, to the at least one sensing device 20 by a fifth electrical line 28, to the metering device 24 by a sixth electrical line 29, and to a mating interface 55 by a seventh electrical line 35. This mating interface 55 is designed to establish a data link with an electronics interface 155 of the container 70 as will be described more fully in the following.

The control unit 50 has at least one microprocessor 51 which communicates with a preferably nonvolatile data and program storage 52. At least one control program and power tool control parameters for the power tool 10 are stored in the data and program storage 52, and measurement data from the sensor means and power tool data are stored therein during operation of the power tool 10. If necessary, the stored measurement data and power tool data can be linked to time data originating from a real-time clock 53 connected to the microprocessor 51. Further, the control unit 50 is connected by at least one interface 54 to the other electrical components and switches of the power tool 10 as was already described above.

The container 70 has electronics arranged in a fixedly installed protective housing 71. The electronics comprise a remote data transmission device 30 for wireless, network-supported digital remote data transmission and a position determining device 40 for global positioning.

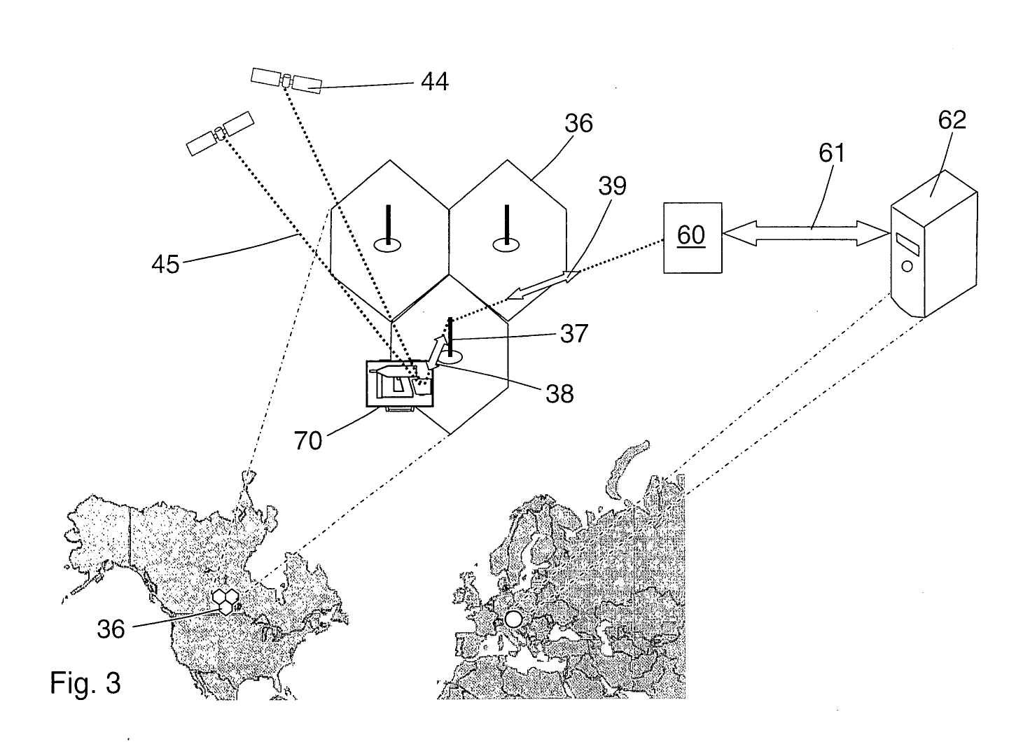

The remote data transmission device 30 has a wireless transmitting and receiving unit 31 formed, e.g., as a GSM module, and a radio antenna 32 which is connected to the latter by an eighth electrical line 33. By GSM is meant a global system for mobile communications as used, e.g., in commercial mobile telephones. The measurement data and power tool data (e.g., operating state data) of the power tool 10 can be sent to a preferably central evaluation location 62 (represented by a personal computer in FIG. 3) by the remote data transmission device 30 as will be described more fully in the following.

The position determining device 40 has a GPS module 41 and an antenna 42 connected to the latter by a ninth electrical line 43. By GPS is meant a global positioning system such as is used in commercial navigating devices. The location of the hand-held power tool 10 can be determined by satellite through the position determining device 40 and can be sent to a evaluation location 62 when transmitting data from the power tool 10 via the remote data transmission device 30.

The GSM module 31 and the GPS module 41 are combined to form a GPS-GSM unit 34. The radio antenna 32 and the antenna 42 are arranged in the immediate vicinity of an outer wall 72 of the container 70 so as to ensure good reception.

The electronics in the container 70 have a data processing and control unit 150 containing at least one microprocessor 151 and a data and program storage 152. The data processing and control unit 150 and, therefore, the microprocessor 151 are connected to the GPS-GSM unit 34. The data processing and control unit 150 can be connected by an electronics interface 155 formed as an RFID interface to a mating interface 55 of the power tool 10 and to its control unit 50 for data transmission. The electronics interface 155 has an RFID antenna 155a which is arranged in the protective housing 71 in such a way that an antenna 55a of the mating interface 55 of the power tool 10 is adjacent to it when the power tool 10 is placed in the container 70. The mating interface 55 is connected to the control unit by a seventh electrical line 35. The electronics also have a self-contained energy source 122, e.g., a battery, for supplying electrical energy.

During the operation of the power tool 10, as was already mentioned, the control unit 50 of the power tool 10 acquires power tool data (e.g., identification data, setting cadence, setting rate, time stamp, device temperature and/or ambient temperature, fill level of a fuel reservoir, charge state of a power source (e.g., a battery), fuel metering amount, battery load voltage, battery open-circuit voltage, type of fuel reservoir, function data of a metering device, trigger and/or switch actuation, undervoltage cutoffs, error logs, malfunctions) from the power tool 10 and measurement data from the sensing means 20 and, if appropriate, links these data to time data originating from the real-time clock 53. Based on a program running in the control unit 50, the mating interface 55 is activated at a predefined time (e.g., daily at 0:00 hours, local time) preferably when the power tool 10 is in rest mode, and by communicating with the electronics interface 155 of the electronics in the container 70 the mating interface 55 activates the electronics with the remote data transmission device 30. The microprocessor 51 and, therefore, the control unit 50 are awakened from sleep mode by suitable triggering means (software or hardware).

Alternatively, awakening can also be carried out by the data processing and control unit 150 in the container 70. This can take place either in a timed manner (in this case, a real-time clock, not shown in the drawings, would be integrated in the electronics of the container 70) or through a switching device 156, e.g., a pushbutton switch, provided at the container.

As can be seen from FIG. 3, the GPS module 41 in the container 70 after waking initially receives the coordinates (dotted line 45) representing the instantaneous geographical position of the container 70 (and therefore also that of the power tool 10) and the UTC time (coordinated universal time) from satellite 44 via the associated antenna 42. These position data and the UTC time are initially conveyed from the GPS module 41 of the GPS-GSM unit 34 to the data processing and control unit 150 and then, via the electronics interface 155 and the mating interface 55, to the control unit 50 in the power tool, where they are put together with measurement data and power tool data which are read out from the data and program storage to form a data package which is now sent to the GSM module 31 of the GPS-GSM unit 34 on the return path. These data are sent (arrow 38 in FIG. 3) from the GSM module 31, e.g., in the form of at least one SMS (Short Message Service), via the radio antenna 32 in the GSM network (indicated in FIG. 3 by the honeycombs 36 of the wireless network). The message is then received by at least one network antenna 37 of the GSM network and sent within the GSM network (arrow 39 in FIG. 3). The data are sent from the GSM network to the Internet (reference number 60) and are sent within the Internet to a personal computer of the evaluation location 62. Device control parameters, changes in the operating program, or new programs can also be sent from the evaluation location 62 to the control unit 50 of the power tool 10 via the GSM network on a return communications path through the remote data transmission device 30 and the electronics interface 155 of the container 70.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A portable container for a hand-held power tool (10), comprising electronics including a remote data transmission device (30) for wireless, network-supported digital remote data transmission, a data processing and control unit (150), a wireless transmitting and receiving unit communicating with the data processing and control unit (150), and a radio antenna (32); and an electronics interface (155) for local data transmission between the remote data transmission device (30) and a hand-held power tool (10).

2. A container according to claim 1, wherein the electronics further comprise a manually actuated switching device (156) for activating the remote data transmission device (30).

3. A container according to claim 2, wherein the manually actuated switching device (156) is accessibly arranged externally at a container wall.

4. A container according to claim 1, wherein the wireless transmitting and receiving unit is formed as a GSM module (31).

5. A container according to claim 1, further comprising a position determining device (40) for global positioning is provided in addition to the remote data transmission device (30) and which communicates with the data processing and control unit (150).

6. A container according to claim 5, wherein the position determining device (40) has a separate antenna (42).

7. A container according to one of claim 5, wherein the position determining device (40) has a GPS module (41).

8. A container according to claim 1, wherein the radio antenna (32) and the antenna (42) are arranged next to an outer wall of the container.

9. A container according to claim 4, wherein the GSM module (31) and the GPS module (41) are combined to form a constructional unit (34).

10. A container according to one of claims 1, wherein power tool data and measurement data of the hand-held power tool (10), which is provided with a control unit (50) for processing measurement data and for controlling device functions, can be sent from the data processing and control unit (150) to an evaluation location (62) by the remote data transmission device (30) with SMS.

11. A container according to claim 1, wherein the power tool control parameters, control programs and control program parts can be sent to the data processing and control unit (150) by the remote data transmission device (30) with SMS.
